(19) United States
(12) Patent Application Publication
(10) Pub. No.: US 2006/0278052 A1
(43) Pub. Date: Dec. 14, 2006

(54) Feeder tube for bar feeder

(75) Inventor: Chih-Hsiung Kuo, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: Barload Machine Co., Ltd., Changhua City (TW)

(21) Appl. No.: 11/452,245

(22) Filed: Jun. 14, 2006

(30) Foreign Application Priority Data
Jun. 14, 2005 (TW) 94119722

(51) Int. Cl. B23B 13/00

(52) U.S. Cl. 82/127

(57) ABSTRACT

For use in a bar feeder, a feeder tube is disclosed to include a holder base and a plurality of support members. The holder base has two hinged holder members each having retaining portions. Each support member has positioning portions respectively detachably engaged with the retaining portions of the holder members, and a bearing portion. The bearing portions of the support members define a cylindrical accommodation space for receiving a bar material therein when the two holder members are close.

### BACKGROUND OF THE INVENTION

1. Field of the Invention

The present invention relates to a bar feeder and specifically, to a feeder tube for bar feeder.

2. Description of the Related Art

In a conventional bar feeder and lathe system, as shown in FIGS. 9 and 10, the bar feeder 90 is provided at the rear side of the automatic lathe 91. The bar feeder 90 has a feeder tube 92, which holds a bar material 93. The bar feeder 90 has a push rod (not shown) controlled to push the bar material 93 toward the automatic lathe 91 for processing.

The aforesaid feeder tube 92 comprises a holder base 94 and a plurality of supporting blocks 95. The supporting blocks 95 are bonded to the holder base 94 with epoxy resin 96. Because the supporting blocks 95 surround the periphery of the bar material 93, the supporting blocks 95 support smooth rotation of the bar material 93 in the feeder tube 92 when the bar material 93 is rotationally forwarding to the lathe 91.

According to the aforesaid design, a toxic gas is produced when bonding the supporting blocks 95 to the holder base 94 with epoxy resin 96. The toxic gas causes an environment pollution problem. Further, frequently rotating a bar material 93 in the feeder tube 92 may cause supporting blocks 95 to wear or to break. When some supporting blocks 95 are damaged, all the supporting blocks 95 and the epoxy resin 96 must be removed from the holder base 94 for a replacement, resulting in a big loss. Further, because a lubricating oil must be applied to the supporting blocks 95 and the periphery of the loaded bar material 93, the epoxy resin 96 will be covered with the applied lubricating oil, resulting in an aging problem. Further, because the epoxy resin 96 tends to deform when hardened, it is difficult to control the application of the epoxy resin 96 and to keep the supporting blocks 95 at the same elevation, resulting in quality instability.

Taiwan patent publication No. 454591 discloses another design of feeder tube for bar feeder. According to this design, the supporting members are affixed to the locating tube with screws, as shown in FIG. 2 of the Taiwan patent publication. In case one supporting member is damaged, the screws must be unfastened from the locating tube so that the damaged supporting member can be replaced with a new one. After replacement, the screw and the supporting members must be installed in the locating tube again. This replacement procedure is time-consuming and complicated.

### SUMMARY OF THE INVENTION

The present invention has been accomplished under the circumstances in view. It is one object of the present invention to provide a feeder tube for bar feeder, which does not produce toxic gas during fabrication, preventing environment pollution.

It is another object of the present invention to provide a feeder tube for bar feeder, which is durable in use, and allows replacement of local parts, thereby saving waste.

It is still another object of the present invention to provide a feeder tube for bar feeder, which uses modularized parts, assuring high precision and high quality and facilitating quick performance of the assembly process.

To achieve these objects of the present invention, the feeder tube for use in a bar feeder for holding a bar material comprises a holder base and a plurality of support members. The holder base comprises two holder members hinged together such that the two holder members are turnable relative to each other between an open position for enabling a bar material to be put in between the two holder members and a close position. The two holder members each have at least one retaining portion. Each of the support members has at least one positioning portion detachably engaged with the at least one retaining portion of one of the holder members, and a bearing portion. The bearing portions of the support members define a cylindrical accommodation space for receiving the bar material therein when the two holder members are turned to the close position.

### BRIEF DESCRIPTION OF THE DRAWINGS

FIG. 1 is an exploded view of a feeder tube in accordance with a first preferred embodiment of the present invention.

FIG. 2 is a cross sectional view of the first preferred embodiment of the present invention, showing the closed status of the feeder tube.

FIG. 3 is a schematic drawing of the first preferred embodiment of the present invention, showing the opened status of the feeder tube in a bar feeder.

FIG. 4 is similar to FIG. 3, but showing a bar material set in the feeder tube and connected to the push rod of the bar feeder.

FIG. 5 corresponds to FIG. 4, showing the feeder tube closed.

FIG. 6 is a cross sectional view of a feeder tube in accordance with a second preferred embodiment of the present invention.

FIG. 7 is a perspective view of one support member for a feeder tube in accordance with a third preferred embodiment of the present invention.

FIG. 8 is a cross sectional view of the feeder tube in accordance with the third embodiment of the present invention.

FIG. 9 is a schematic drawing showing the arrangement of a bar feeder and an automatic lathe according to the prior art.

FIG. 10 is a schematic drawing showing the structure of the feeder tube used in the prior art bar feeder.

### DETAILED DESCRIPTION OF THE INVENTION

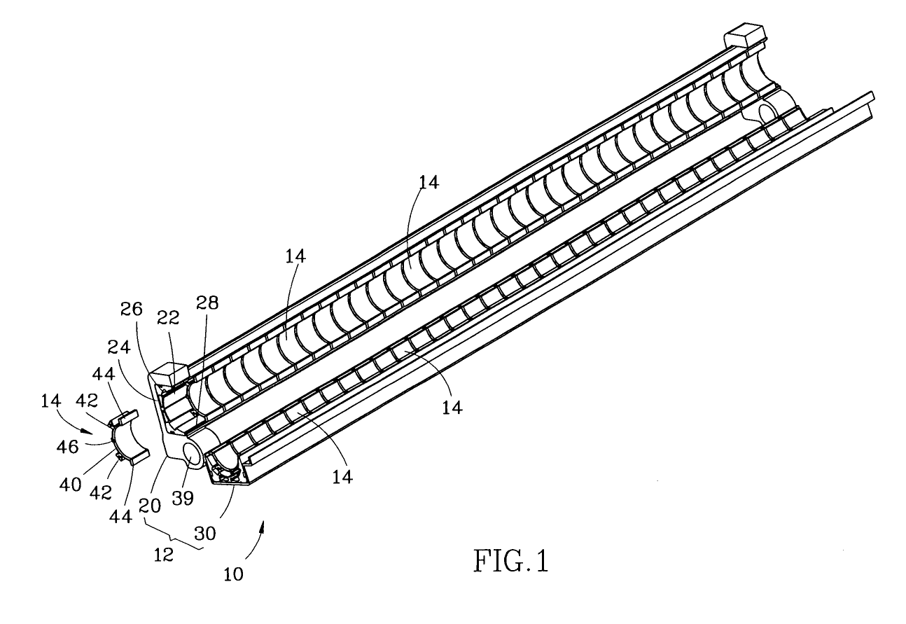

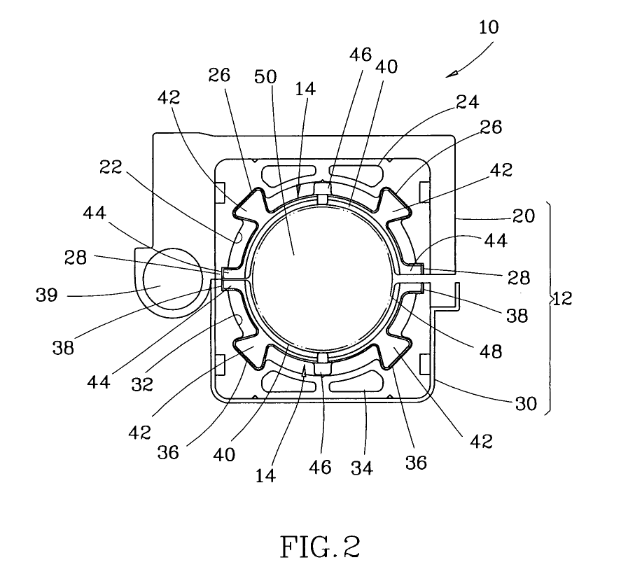

As shown in FIGS. 1 and 2, a feeder tube 10 for use in a bar feeder in accordance with a first preferred embodiment of the present invention comprises a holder base 12 and a plurality of support members 14.

The holder base 12 comprises two elongated holder members, namely, the first holder member 20 and the second holder member 30. The first holder member 20 and the second holder member 30 are respectively extruded from aluminum, each having a longitudinal guide wall 22 or 32, and two longitudinal oil holes 24 or 34 cut through the ends. The longitudinal guide walls 22 and 32 have a cross section shaped like a semicircular arc. Each longitudinal guide wall 22 or 32 has two first recessed retaining portions 26 or 36 and two second recessed retaining portions 28 or 38. The first recessed retaining portion 26 or 36 and the second recessed retaining portion 28 or 38 extend along the length of the respective longitudinal guide wall 22 or 32. The two second recessed retaining portions 28 or 38 are respectively disposed adjacent to the two opposite long sides of the respective longitudinal guide wall 22 or 32. The longitudinal oil holes 24 and 34 are adapted for the filling of lubricating oil.

The first holder member 20 has one long side pivotally coupled to one long side of the second holder member 30 with a pivot shaft 39 so that the first holder member 20 and the second holder member 30 can be turned relative to each other between an open status (see FIG. 1) and a close status (see FIG. 2). When the first holder member 20 and the second holder member 30 are opened, a bar material 50 can be put in between the two holder members 20 and 30. When the first holder member 20 and the second holder member 30 are closed, the holder base 12 shows a tubular shape.

The support members 14 are made of alloy steel, for example, nickel-molybdenum steel by means of powder metallurgy. Each support member 14 has a smoothly arched bearing portion 40, two first positioning portions 42 and two second positioning portions 44 respectively outwardly extending from the outer wall of the smoothly arched bearing portion 40, and a contacting portion 46. The first positioning portions 42 have a cross section fitting the cross section of the first recessed retaining portions 26 and 36. The second positioning portions 44 have a cross section fitting the cross section of the second recessed retaining portions 28 and 38. The contacting portion 46 is equally spaced between the two first positioning portions 42. By means of the first positioning portions 42 and the second positioning portions 44 of the support members 14, the support members 14 are respectively fastened to the first recessed retaining portions 26 and 36 and the second recessed retaining portions 28 and 38 of the first holder member 20 and second holder member 30 of the holder base 12, keeping the contacting portions 46 respectively stopped against the longitudinal guide walls 22 and 32 of the first holder member 20 and second holder member 30 of the holder base 12. When installed, the support members 14 are arranged along the length of the associating longitudinal guide walls 22 and 32 and kept abutted against one another on the associating longitudinal guide walls 22 and 32 such that the smoothly arched bearing portions 40 of the support members 14 define a cylindrical accommodation space 48 for receiving a bar material 50. Further, the lubricating oil can directly flow from the oil holes 24 and 34 to the smoothly arched bearing portions 40 of the support members 14 to reduce friction between the bar material 50 and the support members 14, thereby eliminating noises and increasing shock absorbing effect.

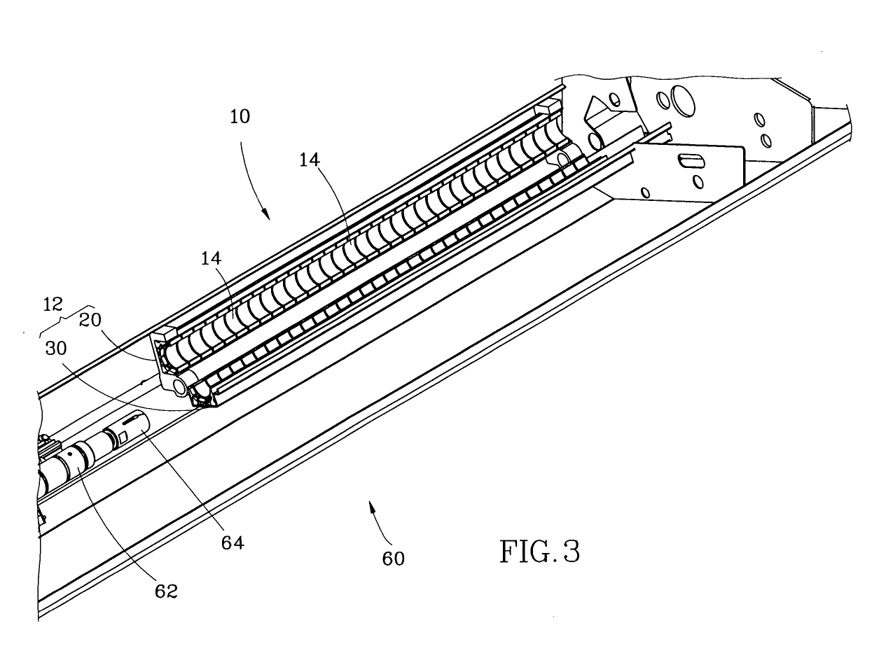

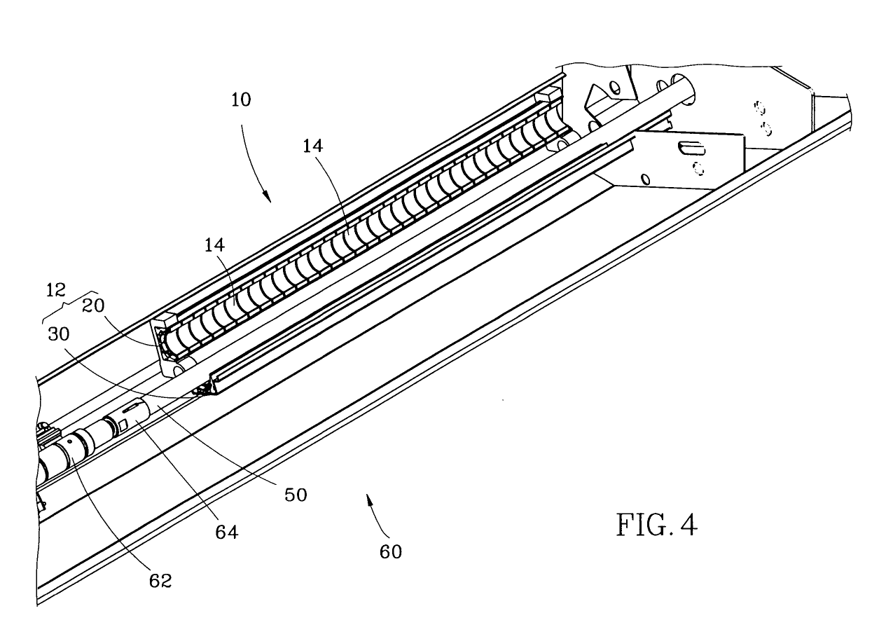

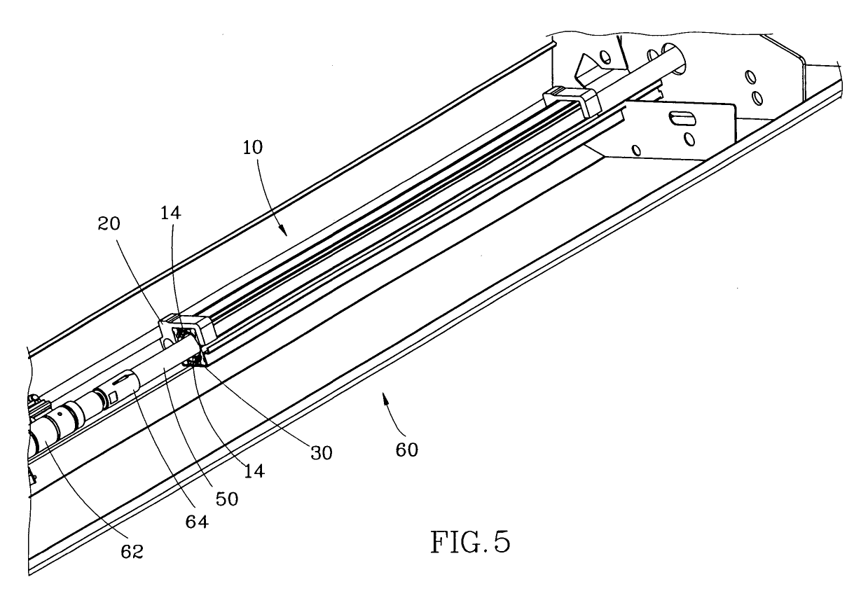

When the feeder tube 10 is installed in a bar feeder 60 and the first holder member 20 and second holder member 30 of the holder base 12 are opened, as shown in FIGS. 3 and 4, a bar material 50 can be put in between the two holder members 20 and 30. After loading of the bar material 50, the two holder members 20 and 30 are closed, as shown in FIG. 5, keeping the smoothly arched bearing portions 40 of the support members 14 abutted against the periphery of the bar material 50. The push rod 62 of the bar feeder 60 is then connected to one end of the bar material 50 with a connector 64, and the other end of the bar material 50 is inserted into the spindle of the lathe (not shown) for allowing rotation of the bar material 50 with the spindle of the lathe. During rotation of the spindle of the lathe, the push rod 62 is controlled to push the bar material 50 in direction toward the lathe. At this time, the smoothly arched bearing portions 40 of the support members 14 support smooth rotation of the bar material 50 in the holder base 12 with the spindle of the lathe. At the same time, the lubricating oil flows out of the oil holes 24 and 34 of the holder base 12 to lubricate the smoothly arched bearing portions 40 of the support members 14, allowing smooth rotation of he bar material 50 in the support members 14.

Because the holder base 12 and the support members 14 are made by means of machinery and molds, the invention eliminates the toxic gas and environment protection problems of the prior art design due to the use of epoxy resin. Further, the invention does not have material aging and deformation problems as encountered in the prior art design. During rotation of the bar material 50 in the holder base 12, some support members 14 may be damaged due to vibration or friction. Because the holder base 12 and the support members 14 are made through a modularized production and assembly process, damaged support members 14 are replaceable, i.e., the support members 14 can be moved out of the holder base 12 along the first recessed retaining portion 26 or 36 and the second recessed retaining portion 28 or 38, and then damaged support members 14 are replaced with new support members 14, and then the support members 14 put back into the holder base 12 after replacement of damaged support members 14 with new support members.

Therefore, during the fabrication of the feeder tube according to the present invention does not produce toxic gas, preventing environment pollution. Further, the component parts of the feeder tube are not easy to have the aging problem. Further, the modularized fabrication of the component parts of the feeder tube allows quick and convenient replacement locally, saving waste.

In the aforesaid first embodiment, the retaining portions are curved inwards on the respective guide walls and the positioning portions are protruded from the respective support members. Alternatively, the retaining portions can be made protruded from the respective guide walls and the positioning portions can be recessed means curved inwards on the respectively support members.

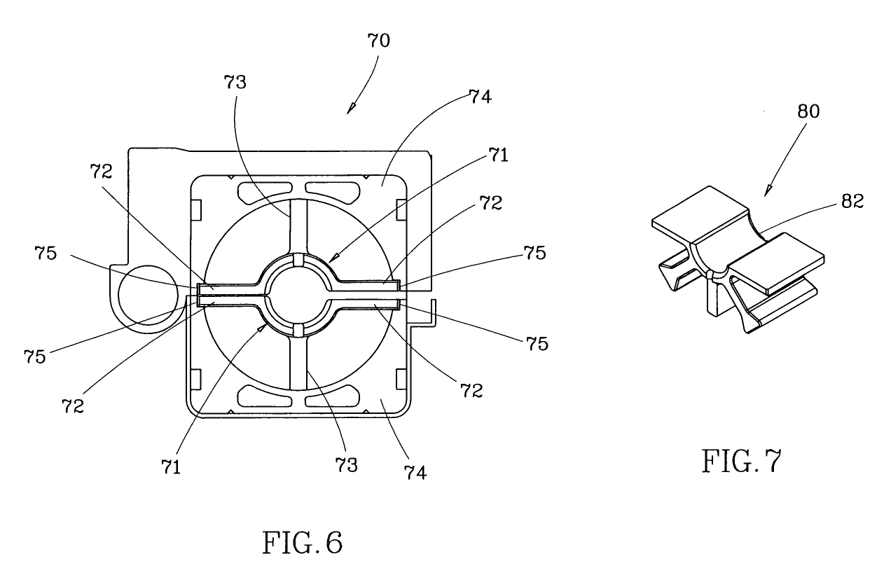

FIG. 6 shows a feeder tube 70 in accordance with a second preferred embodiment of the present invention. According to this second embodiment, each support member 71 has two positioning portions 72 and one contacting portion 73; each holder member 74 has two retaining portions 75 corresponding to the positioning portions 72. Same as the aforesaid first embodiment, this second embodiment allows installation of the support members in the holder base in a replaceable manner. Further, reinforced plastics may be used to substitute for alloy steel for making the support members. Subject to the condition of use, support members of different materials may be used in the same holder member.

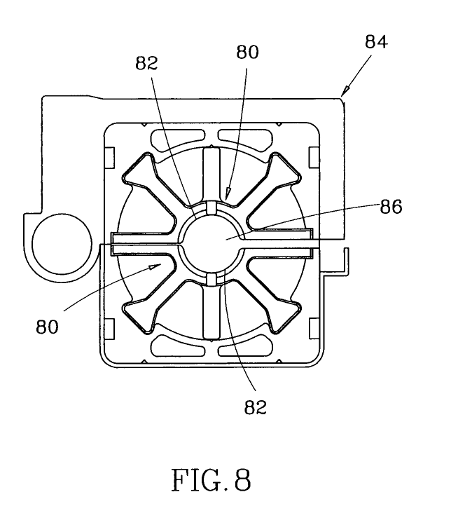

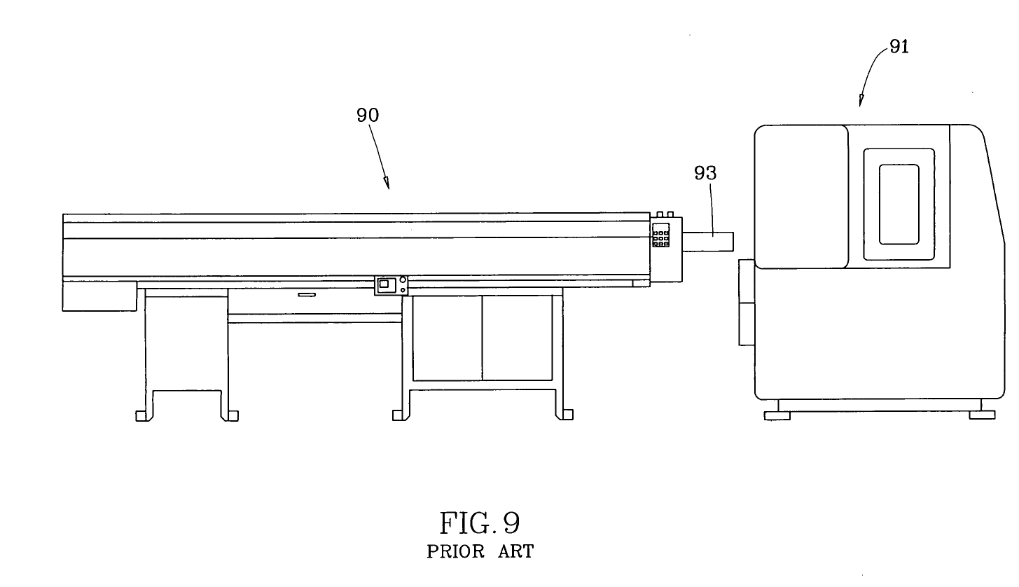

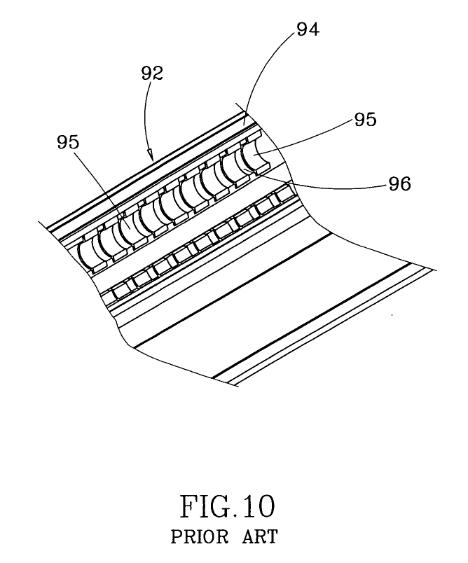

FIGS. 7 and 8 show a feeder tube in accordance with a third preferred embodiment of the present invention. According to this third embodiment, the support members 80 are substantially similar to the aforesaid first embodiment with the exception that the diameter of the smoothly arched bearing portion 82 is relatively smaller. When the support members 80 are installed in the holder base 84, the cylindrical accommodation space 86 is relatively smaller for holding a bar material having a relatively smaller outer diameter. Thus, the holder base 84 can be used with different support members to support a different size of bar material for processing.

What is claimed is:

1. A feeder tube for a bar feeder for holding a bar material, the feeder tube comprising:
a holder base having two holder members hinged together such that said two holder members are turnable relative to each other between an open position and a close position; wherein said two holder members each have at least one retaining portion; and
a plurality of support members, each of which has at least one positioning portion detachably engaged with the at least one retaining portion of one of said holder members, and a bearing portion; wherein the bearing portions of said support members define a cylindrical accommodation space for receiving a bar material therein when said two holder members are turned to the close position.

2. The feeder tube as claimed in claim 1, wherein said two holder members each have a longitudinal guide wall extending along the length thereof; the at least one retaining portion of each of said two holder members each is a recessed retaining portion formed on the longitudinal guide wall of the respective holder member.

3. The feeder tube as claimed in claim 2, wherein the bearing portion of each of said support members has a shape of semicircular arc; the at least one positioning portion of each of said support members is respectively protruded from an outer side of the respective bearing portion.

4. The feeder tube as claimed in claim 1, wherein said two holder members each have a longitudinal guide wall extending along the length thereof; the at least one retaining portion of each of said two holder members respectively outwardly protrudes along the longitudinal guide wall of the respective holder member.

5. The feeder tube as claimed in claim 4, wherein the bearing portion of each of said support members has a shape of semicircular arc; the at least one positioning portion of each of said support members is respectively a recessed positioning portion formed on an outer side of the respective bearing portion and curved inwards.

6. The feeder tube as claimed in claim 1, wherein said two holder members each have a longitudinal guide wall extending along the length thereof; said support members each have a contacting portion pressed on the longitudinal guide wall of the associating holder member.

7. The feeder tube as claimed in claim 1, wherein said holder base has at least one oil hole for the feeding of a lubricating oil to lubricate said support members.
